(19) United States
(12) Patent Application Publication
(10) Pub. No.: US 2026/0357530 A1
(43) Pub. Date: Nov. 12, 2026

(54) MANHOLE COVER LOCK

(71) Applicant: LIDSAFE DESIGNS INC., Rocky View County (CA)

(72) Inventors: Martin Frayn, Wheatland County (CA); Evan Markin, Wheatland County (CA); Matthew Frayn, Wheatland County (CA)

(21) Appl. No.: 19/547,874

(22) Filed: Feb. 24, 2026

Related U.S. Application Data
(63) Continuation of application No. PCT/IB2025/050145, filed on Jan. 7, 2025.

(51) Int. Cl. E02D 29/14; E05B 35/00

(52) U.S. Cl. CPC E02D 29/1427; E05B 35/008

(57) ABSTRACT

A manhole cover lock is configured to be mounted to a hole of a manhole cover and operable to prevent removing the manhole cover from its corresponding ring. The manhole cover lock has a lock passage that extends entirely through the lock to prevent debris from accumulating in the lock and to allow clearing debris from the lock by pushing the debris through the lock passage. An actuator is configured to be removably inserted into the lock passage to operate the lock to move a locking arm between locked and unlocked positions.

### CROSS-REFERENCE TO RELATED APPLICATIONS

This application is a continuation of PCT/IB2025/050145 filed January 7, 2025, the entirety of which is incorporated herein by reference.

### FIELD OF THE INVENTION

The invention relates to manhole covers and, more particularly to manhole cover locks.

### BACKGROUND OF THE INVENTION

Manhole covers are essential components of urban infrastructure, providing access to underground utilities such as sewer systems, electrical lines, and telecommunications networks. They are typically constructed from cast iron, steel, or composite materials.

Manhole covers may incorporate locking mechanisms to mitigate theft and unauthorized access. However, existing locks have drawbacks. Some require purchasing a new manhole cover and a complementary manhole ring. Others may require modifying the manhole cover and/or ring to accept the lock. Many are prone to mechanical failure due to prolonged exposure to environmental conditions, including water, dirt, snow, ice, or any other road-related debris and grime.

### SUMMARY OF THE INVENTION

The present disclosure provides a new and innovative manhole cover lock for locking manhole covers. The manhole cover lock can be configured to mount an existing hole in a manhole cover, thereby allowing use of the lock with numerous preexisting manhole covers. The manhole cover lock is also designed with a straight through lock passage to prevent debris from accumulating in the lock and allowing clearing of the lock passage.

In an example, the manhole cover lock has a lock body for mounting to a manhole cover. The lock body may have a first end, a second end, and a lock body passage. A rotating member is connected to the lock body. The rotating member rotatable relative to the lock body about an axis and is slidable relative to the lock body in a direction along the axis. The rotating member may have a first end, a second end, and a lock passage extending completely therethrough. A lock arm is fixedly attached to the second end of the rotating member for conjoined movement with the rotating member. A spring is disposed in the lock body passage and urges the rotating member in a direction toward the first end of the lock body. An actuator is removably receivable in the locking passage for sliding back-and-forth therein and for rotating therein. The actuator may have a feature that is releasably engageable with the rotating member, wherein when the feature is engaged with the rotating member, rotating the actuator about the axis causes the rotating member to rotate about the axis, and pushing the actuator in a direction toward the second end of the lock body with enough force to overcome a compression force of the spring causes the rotating member to slide in the lock body in the same direction. The actuator is slidable in the locking passage to extend beyond the second end of the rotating member for clearing the locking passage of debris located therein.

In aspects, the engagement feature may include at least one ball detent that is movable to be removably positioned in a hole formed in a sidewall of the rotation member. In aspects, the hole may be a slot.

In aspects, the actuator may have an actuator shaft and a push rod slidably received in a passage of the actuator shaft. The actuator shaft is removably receivable in the locking passage for sliding back-and-forth therein and for rotating therein for operating the rotating member.

In aspects, an alignment tab may be fixedly attached to the second end of the rotating member for conjoined movement with the rotating member. The lock may have a first notch that is configured to removably receive the locking arm and a second notch that is configured to removably receive the alignment tab and exclude the locking arm.

Additional features and advantages of the disclosed apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter, unless stated otherwise.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label, irrespective of the second reference label. No attempt is made to show the structural details of the embodiments in more detail than is necessary for a fundamental understanding of the invention.

FIG. 1 illustrates a perspective, partial view of a manhole cover and ring shown in cross-section and a manhole cover lock according to an aspect of the present disclosure attached to the manhole hole cover.

FIG. 2 illustrates a cross-sectional view of a manhole cover lock according to an aspect of the present disclosure.

FIG. 3 illustrates a perspective view of a manhole cover lock according to an aspect of the present disclosure.

FIG. 4 illustrates a perspective, exploded view of an assembly of a manhole cover lock according to an aspect of the present disclosure.

FIG. 5 illustrates a perspective view of a lock actuator according to an aspect of the present disclosure.

FIG. 6 illustrates a cross-sectional view of a lock actuator according to an aspect of the present disclosure.

FIG. 7 illustrates an enlarged, cross-sectional view of a lock actuator according to an aspect of the present disclosure.

FIG. 8 illustrates a cross-sectional view of a manhole cover lock and lock actuator according to an aspect of the present disclosure.

FIG. 9 illustrates another cross-sectional view of a manhole cover lock and lock actuator according to an aspect of the present disclosure.

FIG. 10 illustrates a perspective view of a manhole cover lock according to another aspect of the present disclosure.

FIG. 11 illustrates a perspective view of a cap of the manhole cover lock of FIG. 10.

FIG. 12 illustrates another perspective view of the manhole cover lock of FIG. 10 and a lock actuator according to another aspect of the present disclosure.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized, and changes can be made without departing from the scope of the disclosure.

Embodiments of the disclosure provide a manhole cover lock that can be fitted to existing manhole covers and has a passthrough design that permits clearing the lock of debris and grime.

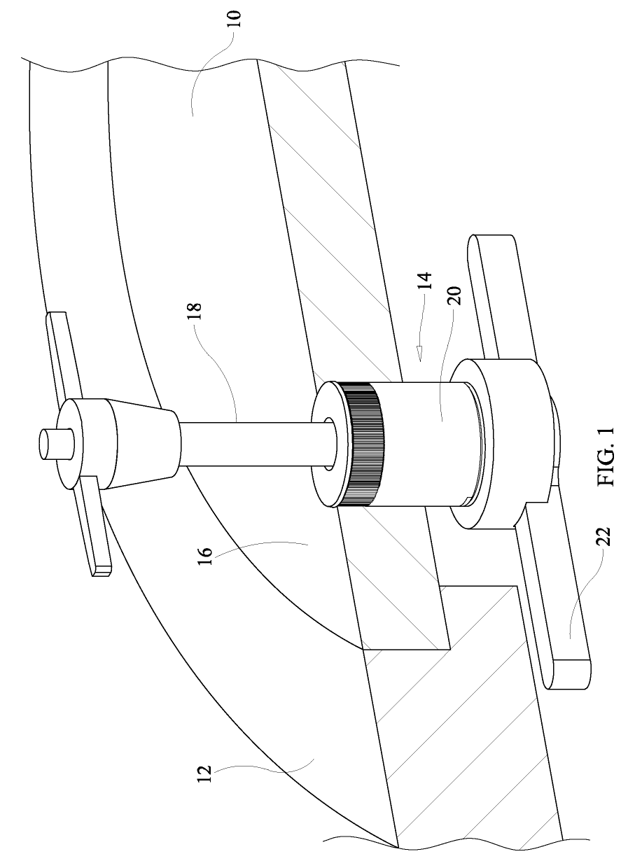

Referring to FIG. 1 of the drawings, a sectional view of a manhole cover 10 seated in a corresponding ring 12 that is conventionally recessed to a paved surface (not shown). Further shown is a manhole cover lock 14 that is mounted to the cover 10 in a hole 16 through the cover and a lock actuator 18 inserted into the lock. Lock 14 has a lock body 20 that is inserted into hole 16, which may be an existing hole in the cover 12. Lock body 20 may be cylindrical as shown and may be dimensioned relative to hole 16 such that the lock body 20 may be press fit or hammered through the hole to attach to the lock to the cover.

As further shown, lock 14 has a lock arm 22 that is rotatable between a locked position (shown in solid line) and an unlocked position (shown in broken line). In the locked position, the lock arm 22 extends from the lock body 20 toward the ring 12 in a position to engage the rim to prevent cover 10 from being lifted off the ring. In the unlocked position, the lock arm 22 extends from the lock body 20 in a position so as not to engage the ring 12 to allow the cover 10 to be lifted off the rim. As will be further described, the lock arm 22 is rotated between the locked and unlocked position using the key actuator 18.

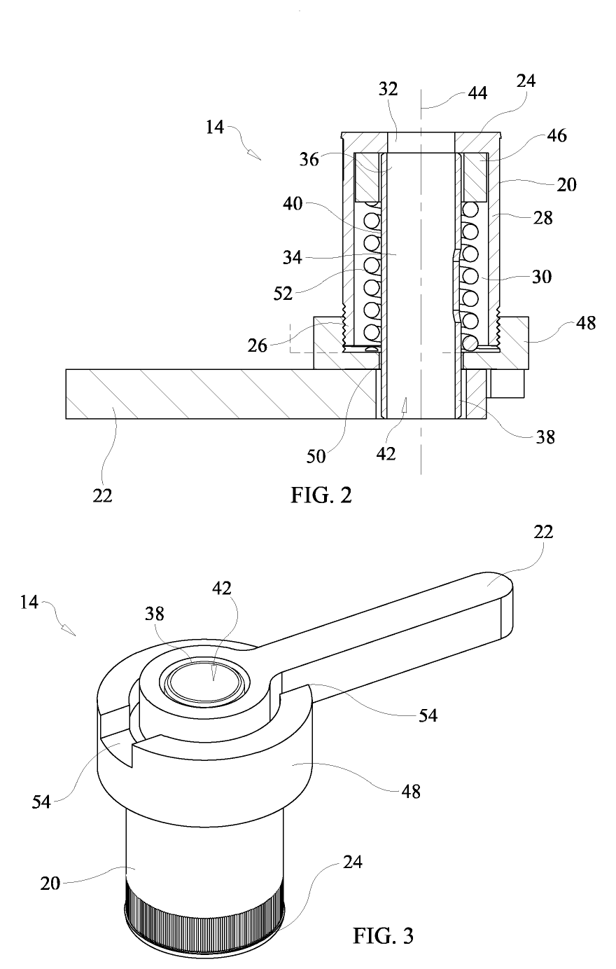

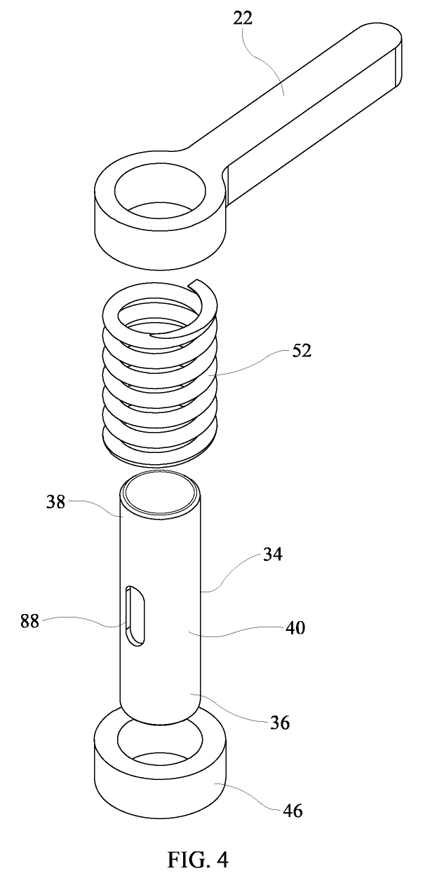

With further reference to FIGS. 2-4, lock body 20 may be cylindrically shaped and have a first end 24, a second end 26 opposite the first end, a sidewall 28 and an internal passage 30 that extends between the first and second ends. As shown, the first end 24 may be a closed end with a hole 32 therethrough into the passage 30, and the second end may be open. When the lock body 20 is mounted in a hole in a manhole cover, first end 24 may be flush with a top surface of the manhole cover and the second end 26 may extend beyond a bottom surface of the manhole cover (as best seen in FIG. 1).

Lock 14 further has a rotating member 34 that is connected to the lock body 20. The rotating member may be cylindrically shaped and have a first end 36, second end 38 opposite the first end, a sidewall 40 extending between the first and second ends thereof, and a lock passage 42 extending completely therethrough. The rotating member 34 is disposed in passage 30 of the lock body 20 and is captively held therein and is rotatable relative to the locking body 20 about an axis of rotation 44 and is slidable relative to the locking body back-and-forth in a direction along the axis 44. In the representative shown embodiment, a bushing 46 may be fixedly attached to the first end 36 of the rotating member and a cap 48 may be connected, via threads for example, to the second end 26 of the lock body 20 with the second end 38 of the rotating member extending beyond the second end of the lock body and through a hole 50 in the cap.

A spring may be disposed in the passage 30, such as coil spring 52 that extends between the bushing 46 and the cap 48 and operates to urge the rotating member in a direction toward the first end 26 of the lock body. As shown, the spring 52 may be in the passage 30 in the annular space between the sidewalls 28 and 40 of the lock body and rotating member, respectively.

The lock arm 22 is fixedly attached to the second end 34 of the rotating member 34 for conjoined movement with the rotating member. In an aspect, cap 48 may have diametrically opposed notches 54. The notches are configured to receive the locking arm 22 in the locked and unlocked positions and to prevent unwanted rotation of the locking arm.

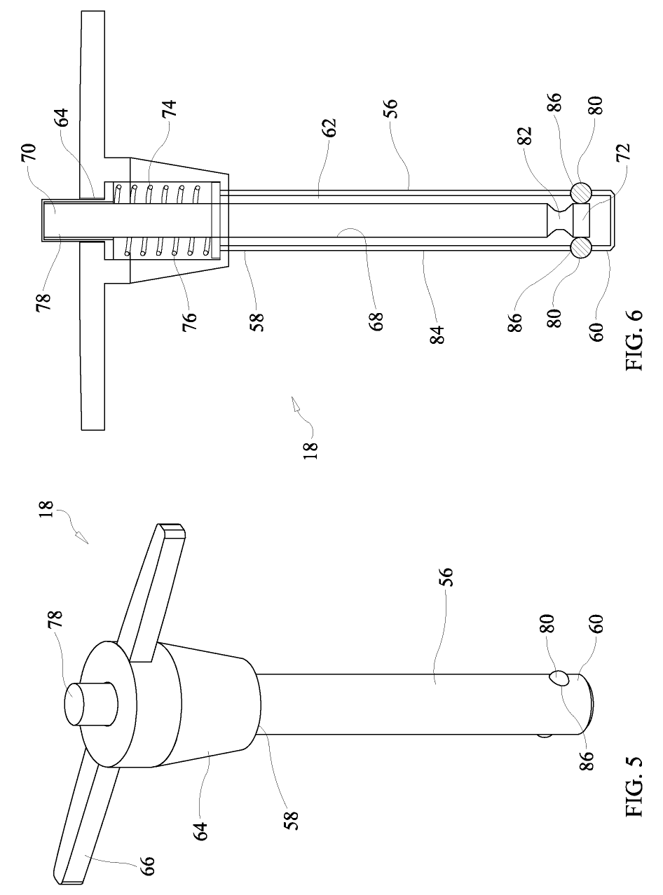

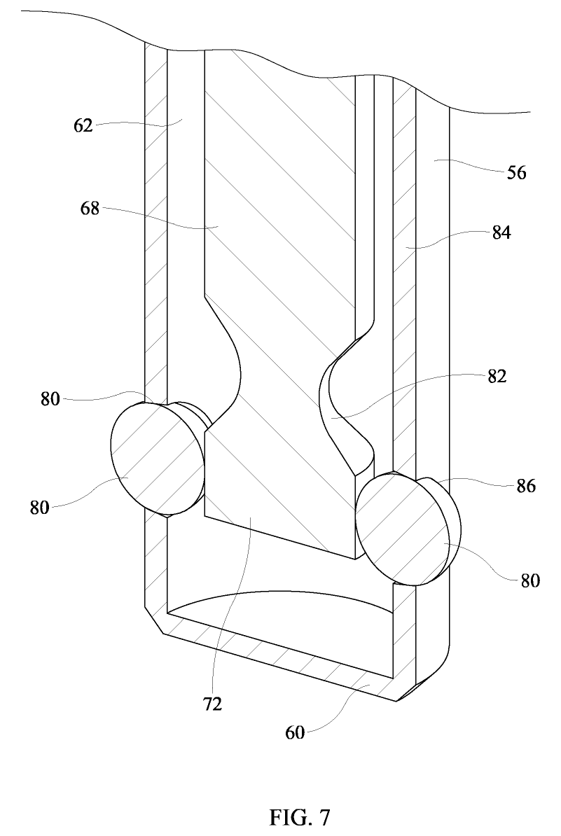

With reference to FIGS. 5-7, actuator 18 is configured to operate lock 14 to position the lock arm 22 in the locked and unlocked positions. As representatively shown, actuator 18 has an elongated shaft 56 with opposite first and second ends 58 and 60, and an internal passage 62 extending between the first and second ends. A housing 64 is connected to the first end 58 of shaft 56 and has a t-handle 66 for grasping by a user. A push rod 68 extends through the housing 64 and into the internal passage 62 of the shaft 56 and is movable relative to the shaft. The first end 70 of the push rod 68 extends through a hole in the housing 64 in an opposite direction of the shaft 56 with the second end 72 being disposed in the shaft toward its second end 60. A spring, such as coil spring 74 is located in an internal space 76 in housing 64 and is configured to urge the push rod 68 in a direction away from the second end 60 of the shaft. In the representatively illustrated embodiment, a button 78 is attached the first end 70 of the push rod 68 and extends into the housing through the same hole as the push rod and into the internal space 76.

Actuator 18 further has an engagement feature configured to selectively engage with the rotating member 34 to operate it. As representatively illustrated, this engagement feature may include a pair of ball detents 80 held captive in the shaft passage 62 and movable to selectively engage with the rotating member. The second end 72 of the push rod 68 has a circumferential groove 82 and the sidewall 84 of the shaft 56 has a pair of diametrically opposed detent holes 86 having a diameter that is slightly less than the diameter of the ball detents 80. Moving the push rod 68 in the shaft 56 (i.e., by pressing on its first end 70 which extends outwardly from the housing 64), selectively positions the ball detents 80 in either the groove 82 or in detent holes 86 where the balls extend partially through the sidewall 84 but remain captive in the shaft.

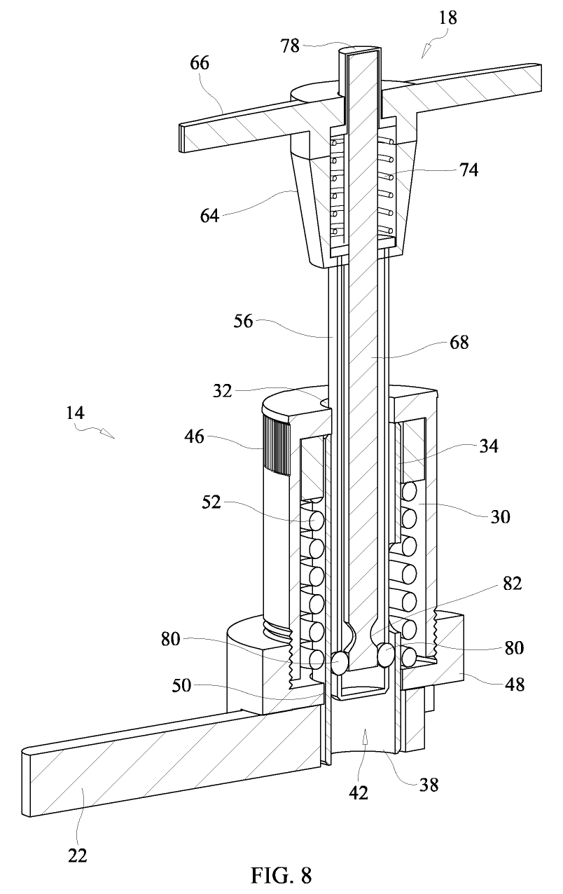

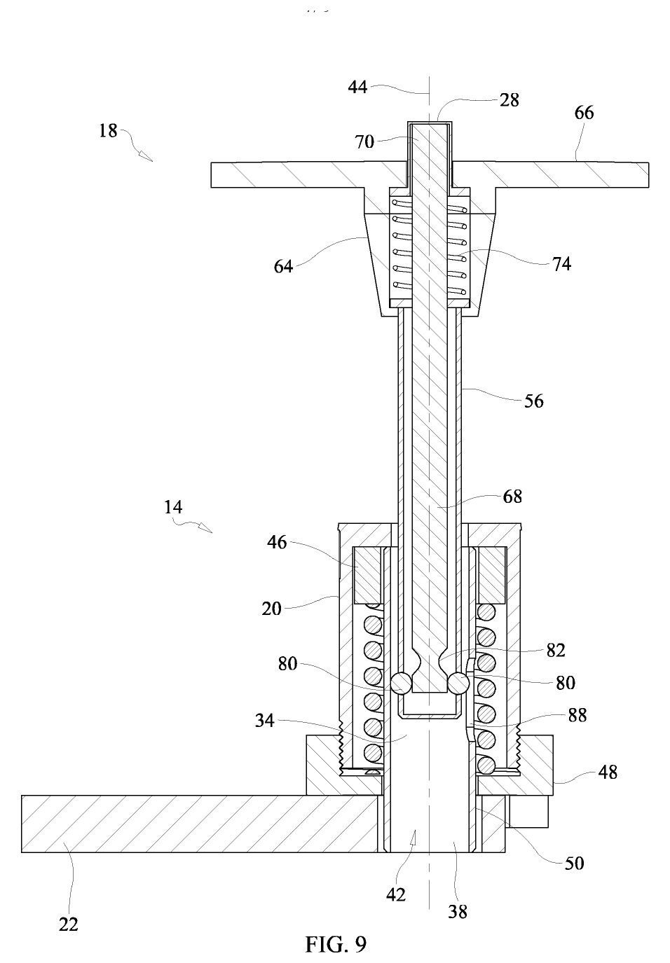

With reference to FIGS. 8-9, the actuator shaft 56 is configured to be inserted into the lock passage 42 through lock body hole 32 and the first end 36 of the rotating member 34. The actuator shaft 56 may have a length that is greater than the length of the rotating member 34 such that the shaft may be pushed completely through the lock passage 42 to remove any debris that may accumulate in the passage. In FIG. 8, the ball detents 80 are shown in the groove 82 in the push rod 68 and held captive between the push rod and the sidewall 84. In FIG. 9, the ball detents are shown extending through detent holes 86 and held in position by the side of the push rod 68 (i.e., the detents are not located in the groove in this position, so they are forced through the holes and held in place therein). In this position, one of the ball detents 80 engages with a slot 88 (i.e., partially extends into the slot) formed in the sidewall 40 of the rotating member 34. In this engaged position, rotating the actuator shaft 56 about axis 44 rotates the rotating member about the axis. Similarly, pushing the actuator shaft 56 in a direction inwardly or toward the second end of the lock body 20 moves the rotating member 34 in the same direction along the axis.

Lock 14 is operated by actuator 18 to selectively move the locking arm 22 in locked and unlocked positions as desired. In operation, a user holding the actuator 18 by the t-handle in one hand, can push on the end of the push rod 68 extending upwardly from the housing 64 to push the rod in a direction into the actuator shaft 56. Such a movement of the push rod 68 causes the ball detents 80 to be moved into the circumferential groove 82 on the rod, allowing the shaft 56 to be inserted into the lock passage 42 through the opening 32 in the lock body 20.

Once the shaft is inserted into the lock passage, a user may release the push rod allowing push rod spring 74 to urge the push rod in an opposite direction which urges the ball detents 80 outwardly against the sidewall of the shaft. Shaft 56 can be moved back-and-forth and rotated in the lock passage 42 to align one of the ball detents 80 with the slot 88 in the sidewall of the rotating member 34. Once aligned, one ball detent extends outwardly into the slot and the other presses against the sidewall of the shaft, thereby further engaging the opposite ball with the slot.

Once the ball detent 80 is engaged with slot 88, rotating the actuator shaft 56 by the t-handle, also rotates the rotating member 34 relative to the lock body 20. Pushing the actuator shaft inwardly (i.e., in a direction toward the second end 20 of the lock body) also moves the rotating member in the same direction. To move the locking arm 22 between the locked and unlocked positions, while the actuator is engaged with the rotating member 34, the actuator shaft is pushed against the force of spring 52 to move the rotating member along the lock body a sufficient distance to move the locking arm from a respective notch 54 and once removed from the notch, rotate the locking arm to align with the opposite notch. Pushing the push rod once again disengages the ball detent from the slot and thus disengages the actuator from the lock, allowing its removal from the locking passage. Spring 52 urges against the rotating member 34, thereby seating the locking arm 22 in the aligned notch.

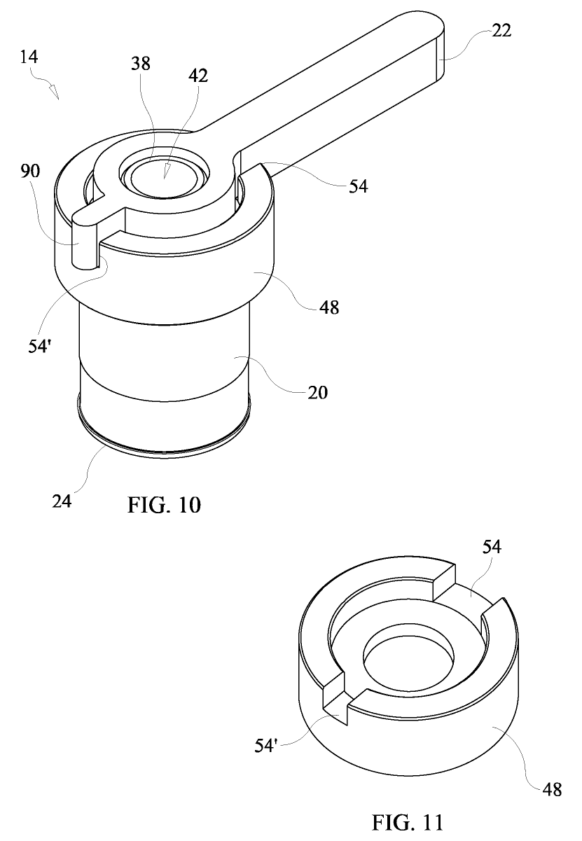

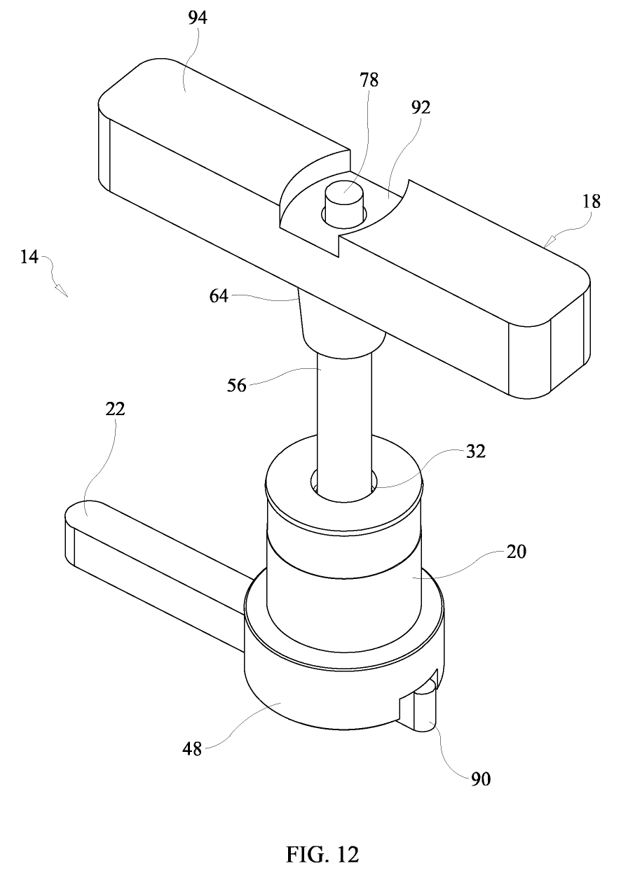

With reference to FIGS. 10-12, there is shown another exemplary embodiment of a manhole cover lock 10 according to the present disclosure. An alignment tab 90 is connected to the rotating member 34 for conjoined movement with the rotating member. As representatively shown, the alignment tab 90 is diametrically opposite of the locking arm 22. However, the alignment tab 90 could be located in a different radial position relative to the locking arm 22. As further shown, locking arm 22 and the alignment tab 90 may be provided as a single element that is fixedly attached to the rotating member 34.

As further shown, the alignment tab 90 has a smaller width than the width of the locking arm 22. Notch 54 in cap 48 has a width that is sized to receive the locking arm 22 and notch 54’ has a width that is sized to receive the alignment tab 90 but is smaller than the width of the locking arm to exclude the locking arm. To this end, locking arm 22 only has one locking position radially about axis 44, which is when the locking arm is disposed in notch 54. Additionally, alignment tab 90 prevents undesired canting of the rotating member 34 relative to axis 44 by its contact with cap 48.

In FIG. 12, there is shown another exemplary embodiment of actuator 18 according to the present disclosure. As shown, the T-shaped handle 66 has a larger profile to make it more easily grasped by a user’s hand. Handle 66 further has a recess 92 from through its top surface 94. Button 78 is in recess 92 at an elevation below the top surface 94 to prevent unwanted pressing of the button and push rod 68 while a user manipulates the actuator with the handle.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A manhole cover lock for use with a manhole hole cover, the manhole cover lock comprising:
a lock body for mounting to a manhole cover, the lock body having a first end and a second end, the lock body having a passage therethrough;
a rotating member connected to the lock body, the rotating member rotatable relative to the lock body about an axis, the rotating member slidable relative to the lock body in a direction along the axis, the rotating member having a first end, a second end, and a lock passage extending completely therethrough;
a lock arm fixedly attached to the second end of the rotating member for conjoined movement with the rotating member;
a spring, the spring disposed in the passage of the lock body and urging the rotating member in a direction toward the first end of the lock body;
an actuator, the actuator removably receivable in the locking passage for sliding back-and-forth therein and for rotating therein, the actuator having a feature releasably engageable with the rotating member, wherein when the feature is engaged with the rotating member, rotating the actuator about the axis causes the rotating member to rotate about the axis, and pushing the actuator in a direction toward the second end of the lock body with enough force to overcome a compression force of the spring causes the rotating member to slide in the lock body in the same direction; and
wherein the actuator is slidable in the locking passage to extend beyond the second end of the rotating member for clearing the locking passage of debris located therein.

2. The manhole cover lock of claim 1, wherein the lock body has a threaded exterior portion at the second end thereof, and further includes a threaded cap for selectively engaging the threaded portion of the lock body.

3. The manhole cover lock of claim 1, further comprising at least one notch configured to removably receive the locking arm.

4. The manhole cover lock of claim 1, wherein the engagement feature includes at least one ball detent that is movable to be removably positioned in a hole formed in a sidewall of the rotation member.

5. The manhole cover lock of claim 4, wherein the hole is a slot.

6. The manhole cover lock of claim 1, wherein the actuator has an actuator shaft and a push rod slidably received in a passage of the actuator shaft, and wherein the actuator shaft is removably receivable in the locking passage for sliding back-and-forth therein and for rotating therein.

7. The manhole cover lock of claim 6, wherein the actuator has a handle at one end of the actuator shaft, the handle having a recess formed through a top surface of the handle, and further comprising a button disposed in the recess below the top surface, the button coupled to one end of the push rod.

8. The manhole cover lock of claim 1, wherein the spring is a coil spring.

9. The manhole cover lock of claim 1, further comprising:
an alignment tab fixedly attached to the second end of the rotating member for conjoined movement with the rotating member;
a first notch configured to removably receive the locking arm; and
a second notch configured to removably receive the alignment tab and exclude the locking arm.

10. A manhole cover lock for use with a manhole hole cover, the manhole cover lock comprising:
a lock body for mounting to a manhole cover, the lock body being cylindrically shaped and having a first end, a second end, and a lock body passage therethrough;
a rotating member, the rotating member being cylindrically shaped and disposed in the lock body passage, the rotating member rotatable in the lock body passage relative to the lock body about an axis, the rotating member slidable in the lock body passage relative to the lock body in a direction along the axis, the rotating member having a first end, a second end, and a lock passage extending completely therethrough, the second end thereof extending outwardly from the lock body passage beyond the second end of the lock body, the rotating member having a hole formed in a sidewall thereof;
a lock arm fixedly attached to the second end of the rotating member for conjoined movement with the rotational member; and
a spring, the spring disposed in the lock body passage and urging the rotating member in a direction toward the first end of the lock body;
an actuator, the actuator removably receivable in the locking passage for sliding back-and-forth therein and for rotating therein, the actuator having a ball detent that is releasably engageable with the hole with the rotating member, wherein when the ball detent is engaged with the rotating member, rotating the actuator about the axis causes the rotating member to rotate about the axis, and pushing the actuator in a direction toward the second end of the lock body with enough force to overcome a compression force of the spring causes the rotating member to slide in the lock body in the same direction; and
wherein the actuator is slidable in the locking passage to extend beyond the second end of the rotating member for clearing the locking passage of debris located therein.

11. The manhole cover lock of claim 10, wherein the lock body has a threaded exterior portion at the second end thereof, and further includes a threaded cap for selectively engaging the threaded portion of the lock body.

12. The manhole cover lock of claim 11, further comprising:
an alignment tab fixedly attached to the second end of the rotating member for conjoined movement with the rotating member;
a first notch in the threaded cap, the first notch configured to removably receive the locking arm; and
a second notch in the threaded cap, the second notch configured to removably receive the alignment tab and exclude the locking arm.

13. The manhole cover lock of claim 11, wherein the cap has at least one notch configured to removably receive the locking arm.

14. The manhole cover lock of claim 13, wherein the at least one notch includes two diametrically opposed notches.

15. The manhole cover lock of claim 10, wherein the hole in the rotating member sidewall is a slot.

16. The manhole cover lock of claim 10, wherein the actuator has an actuator shaft and a push rod slidably received in a passage of the actuator shaft, and wherein the actuator shaft is removably receivable in the locking passage for sliding back-and-forth therein and for rotating therein, and wherein sliding the push rod in the passage of the actuator selectively engages the ball detent with the hole in the sidewall of the rotating member.

17. The manhole cover lock of claim 16, wherein the actuator further has a t-handle.

18. The manhole cover lock of claim 17, wherein the t-handle has a recess formed through a top surface of the handle, and further comprising a button disposed in the recess below the top surface, the button coupled to one end of the push rod.

19. The manhole cover lock of claim 10, wherein the spring is a coil spring.
